(19) United States
(12) Patent Application Publication
(10) Pub. No.: US 2013/0334093 A1
(43) Pub. Date: Dec. 19, 2013

(54) DECORATIVE CRAFT KITS

(71) Applicant: Paula Mello, Encinitas, CA (US)

(72) Inventor: Paula Mello, Encinitas, CA (US)

(73) Assignee: Crafty Productions, Inc., San Marcos, CA (US)

(21) Appl. No.: 13/495,885

(22) Filed: Jun. 13, 2012

(51) Int. Cl. B65D 71/00; B23P 11/00

(52) U.S. Cl. 206/575; 29/428

(57) ABSTRACT

Some embodiments of the present application relate to decorative art craft kits and associated method of using the kits for embellishing various decorative craft items. The kit comprises a first craft item having a substantially flat surface and raised edges defining the shape of said first craft item, a removable template removably attached to said substantially flat surface of said first craft item, and instructions on said template regarding the use of the kit. The surface can also comprise additional decorative elements. Some embodiments of the present application relate to the method of manufacturing kits described herein.

### BACKGROUND

1. Field of the Invention

The present application relates to decorative craft kits, such as a kit for embellishing a decorative craft item, and the method of using and manufacturing the same.

2. Description of the Related Art

A wide variety of decorative craft kits is currently available on the market. Some examples of these kits include the clay crafting kits, fabric crafting kits, wood crafting kits, printing kits, etc. Many of the craft kits do not have instructions on how to use the kits. Some of the craft kits comprise written instructions on the packaging of the kits or as separate inserts of the kits. Sometimes, it is cumbersome to constantly switch between reading the instructions from the packaging and performing the steps of instructions. Moreover, it is easy to lose the separate package inserts. There is a need for a craft kit with a readily removable template, wherein the instructions on how to use the kit are imprinted on the template.

### SUMMARY

Some embodiments disclosed herein relate to a kit for embellishing a decorative craft item comprising: a first craft item having a substantially flat surface and raised edges defining the shape of the first craft item; a removable template, wherein the removable template is removably attached to the substantially flat surface of the first craft item; and instructions on the template for removing the removable template from the first craft item and using the template to embellish the decorative craft item.

In some embodiments, the first craft item of the kit comprises a shape selected from the group consisting of a heart, triangle, square, rectangle, oval, circle, cross, star, letter, bone, arrow and animal shapes.

Optionally, the removable template comprises a pull tab. The removable template can be constructed from various materials, for example, flexible plastic, or paper.

In some embodiments, the first craft item of the kit is constructed from a material selected from the group consisting of wood, plastic, paper, clay, rubber, metal, foam and wax.

In some embodiments, the first craft item of the kit comprises wood.

In some embodiments, the instructions further comprise positioning the template onto the surface of a material selected from the group consisting of fabric, lace, leather, stationery, paper, cutting the material along the edges of the template, and adhering the cut material to the substantially flat surface of the first craft item.

In some embodiments, the instructions further comprise tracing said template onto the material before cutting.

In some embodiments, the instructions further comprise advising a user to add one or more craft embellishments to the material adhered to the substantially flat surface of the first craft item.

In some embodiments, the instruction can further comprise using a stencil.

In some embodiments, the craft embellishments are selected from beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

In some embodiments, the kit further comprises a second craft item of a smaller size disposed within the first craft item, wherein the removable template is positioned between the first craft item and the second craft item on the surface of the craft item.

In some embodiments, the first craft item of the kit is selected from the group consisting of a picture frame, a jewelry box frame, a storage box frame, a shadow box frame, and a grid frame.

In some embodiments, the first craft item of the kit is a single, bi-fold or tri-fold picture frame.

In some embodiments, the template of the kit is removably adhered to the first craft item with an adhesive.

Some embodiments disclosed herein relate to a method of embellishing a decorative craft item, comprising: providing a decorative kit having a first craft item, a substantially flat surface and raised edges defining a shape of the first craft item, and a template removably attached to the surface of the first craft item; removing the template from the decorative craft item; cutting the material in the shape of the template; and transferring the cut material onto the surface of the first craft item.

In some embodiments, the method further comprises tracing the shape of the template onto the material before cutting.

In some embodiments, the method further comprises adhering the cut material to the surface of the first craft item.

In some embodiments, the method further comprises embellishing the craft item by adhering a decorative element selected from beads, buttons, gems, shells, charms, ribbons, paints, stains, yarns, threads, flowers, jewels, feathers, mosaic tiles, stickers, fabric felts, wood accents, cabochons, stained glass, metal accents, plastic or EVA accents, glass accents, or combinations thereof

Some embodiments disclosed herein relate to a method of manufacturing a decorative craft kit, comprising: providing a craft item having a substantially flat surface and raised edges defining the shape of the craft item; removably attaching a template to the substantially flat surface of the craft item; providing instructions on the template for removing the template from the craft item and using the template to embellish the decorative craft item.

In some embodiments, the shape of the craft item is selected from heart, triangle, square, rectangle, oval, circle, cross, star, letter, bone, arrow, or animal shapes.

In some embodiments, the template further comprises a pull tab.

In some embodiments, the template is removably attached to the substantially flat surface of the craft item via an adhesive.

In some embodiments, the method of manufacturing the craft kit further comprises attaching additional decorative craft embellishments selected from the group consisting of beads, buttons, gems, pearls, shells, charms, ribbons, paints, stains, pictures, yarn, thread, flowers, jewels, feathers, mosaic tiles, stickers, fabric felts, wood accents, cabochons, stained glass, metal accents, plastic or EVA accents, glass accents, or combinations thereof to the craft item.

### BRIEF DESCRIPTION OF THE DRAWINGS

FIG. 1 depicts a perspective view of a craft kit comprising a first craft item with a substantial flat surface, and a removable template.

FIG. 2 depicts a perspective view of a craft kit comprising a first craft item, and a second craft item of smaller size disposed within the first craft item.

FIG. 3 depicts a perspective view of a craft kit comprising a cross-shaped craft item.

FIG. 4 depicts a perspective view of a shadow box craft kit comprising a first cross-shaped craft item, and a second cross-shaped craft item disposed within the first cross-shaped craft item.

FIG. 5 depicts a perspective view of a craft kit comprising a craft item of letter shape with a substantial flat surface, and a removable template.

FIG. 6 depicts a perspective view of a craft kit comprising a first oval-shaped craft item and a second oval-shaped craft item disposed within the first craft item, and a third letter-shaped craft item disposed within the second craft item.

FIG. 7 depicts a perspective view of a craft box kit comprising a removable template on one unfinished inner surface of the box, and an illustrated finished second inner surface of the box.

FIG. 8 depicts a perspective view of a craft storage box comprising a removable template on the top surface of the box.

### DETAILED DESCRIPTION OF THE PREFERRED EMBODIMENTS

In the following detailed description, examples of the decorative craft kits described herein are for illustrative purposes only and are not to limit the scope of the claims provided herein. Other embodiments can be utilized, and other changes can be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Embodiments of a kit for embellishing a decorative craft item comprises a first craft item having a substantially flat surface and raised edges defining the shape of the first craft item; a removable template, wherein the removable template is removably attached to the substantially flat surface of the first craft item; and instructions on the template for removing the removable template from the first craft item and using the template to embellish the decorative craft item. The first craft item can be constructed from wood, plastic, paper, clay, rubber, metal, foam, wax or other material generally used by a person of ordinary skilled in the art. Embodiments of the first craft item can be in different shapes, such as heart, triangle, square, rectangle, oval, circle, cross, star, letter, bone, arrow, animals, or any other shape commonly used by a person of ordinary skill in the art. The removable template can be constructed from flexible plastic, paper or other material ordinarily used by a person of ordinary skilled in the art. The removable template can optionally comprise a pull tab to help remove the template from the surface of the first craft item. The removable template can be attached to the surface of the first craft item with or without adhesives. Embodiments of the kit can further comprise one or more additional craft items of smaller size disposed within the first craft item. Embodiments of the kits can further comprises additional embellishments such as beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or any other items that are commonly used by a person of ordinary skill in the art.

The term “star” as used herein, refers to the shape of a star of four or more points, as understood by a person or ordinary skill in the art.

The term “letter” as used herein, refers to a written symbol or character representing a speech sound and being a component of an alphabet, for example, English language alphabetical letters.

The term “decorative element” or “embellishment” as used herein, refers to a substrate that is commonly used in an art craft kit, for example, beads, buttons, pearls, gems, shells, charms, pictures, paints, stains, ribbons, yarns, threads, flowers, jewels, feathers, mosaic tiles, stickers, fabric felts, wood accents, cabochons, stained glass, metal accents, plastic or EVA accents, glass accents, or any other items that are commonly used by a person of ordinary skill in the art.

The term “shadow box frame” as used herein, refers to a shallow box of a certain shape with a transparent front used to protect and display items disposed within the box.

The term “grid frame” as used herein, refers to a frame comprising a shape-defining outer frame and additional parallel or perpendicular bars within the outer frame to separate the outer frame into small compartments of the same or different size.

The term “instructions” as used herein, refers to not only word instructions on how to use the craft kits, but can also include picture instructions of suggested embellished kits.

The term “paper” as used herein, refers to any type of papers that is used by a person of ordinary skill in the art, for example, scrapbook paper, wall paper, magazine covers, construction paper, and etc.

The term “adhesive” as used herein, refers to any type of adhesives that is used by a person of ordinary skill in the art, allowing the template to be attached thereto yet readily removable, for example, paper glue, multi-purpose glue, tacky glue, or double-sided adhesive tape.

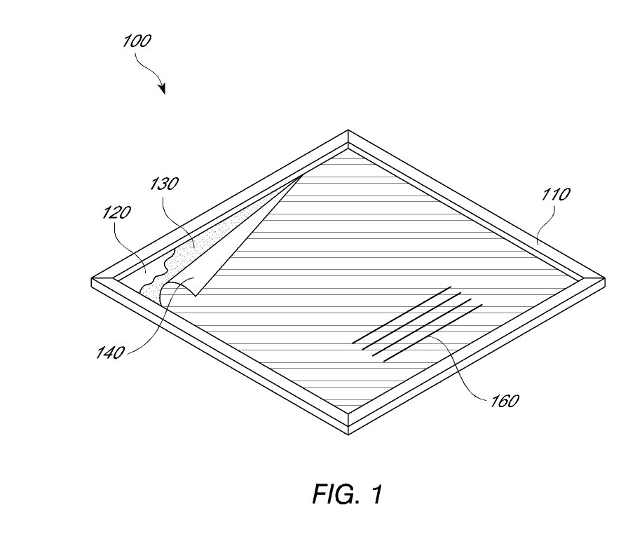

Referring to the Figures, FIG. 1 illustrates a perspective view of an embodiment of a craft kit 100 comprising a first craft item 110 having raised edges defining the shape of the first craft item. As illustrated, the first craft item is in the shape of a square, and includes a substantially flat surface 120. However, it will be appreciated that the first craft item can include any number of shapes having at least one substantially flat surface. Exemplary shapes include, without limitation, heart, triangle, square, rectangle, oval, circle, cross, star, letter, bone, arrow or animals. First craft item 110 can be constructed from various materials. Exemplary materials include, without limitation, wood, plastic, paper, clay, rubber, metal, foam, or wax. In one embodiment, first craft item 110 comprises wood. In some embodiments, first craft item 110 can comprise one or more craft items of smaller sizes disposed within craft item 110.

A removable template 140 is fitted between the raised edges of first craft item 110. Removable template 140 can be attached to surface 120 either directly or indirectly, and can be peeled off partially or completely. Removable template 140 can be constructed from various materials, for example, flexible plastic or paper.

An adhesive layer 130 is optionally present and in direct contact with surface 120. Removable template 140 can be adhered to adhesive layer 130. When adhesive layer 130 is absent, template 140 can be directly attached to surface 120 or directly fitted between the raised edges of craft item 110. Exemplary adhesives used for preparing adhesive layer 130 include, without limitation, paper glue, multi-purpose glue, tacky glue, or double-sided adhesive tape. As illustrated in FIG. 1, the adhesive layer 130 is applied to the surface 120 of the craft item 110. It will be appreciated, however, that in some embodiments, the adhesive layer 130 can be applied directly to the surface of the template 140 and the template 140 can then be removably attached to the surface 120.

Instructions 160 on how to embellish craft kit 100 are imprinted on template 140. Exemplary instructions include, without limitations, instruction on how to use the craft kit, instruction on how to remove the template, instruction on how to trace the craft material using the template, instruction on how to cut the craft material using the template, instruction on how to attach the cut-out material onto surface 120, and instruction on how to add additional embellishments to the craft item. Instructions 160 can also include pictures of the suggested finished embellished craft item. Exemplary embellishments include, without limitation, beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

Craft kit 100 can be used to embellish a craft item in various ways. In some embodiments, a craft kit 100 is provided first. Then, removable template 140 is peeled off from craft kit 100. After removal, template 140 can be placed on a surface of a craft material to trace and cut out the craft material in the shape of template 140. Exemplary craft materials include, without limitation, fabric, lace, leather, stationery, or paper. Then, the cut-out material is transferred onto surface 120 of first craft item 110. In some embodiments, the method further comprises adhering the cut material to surface 120 of first craft item 110. In some embodiments, the method further comprises embellishing craft kit 100 by adhering additional decorative elements, such as beads, buttons, gems, shells, charms, ribbons, paints, stains, yarns, threads, flowers jewels, feathers, mosaic tiles, stickers, fabric felts, wood accents, cabochons, stained glass, metal accents, plastic or EVA accents, glass accents, or combinations thereof

Craft kit 100 can be manufactured via various methods. In some embodiments, first craft item 110 having a substantially flat surface 120 and raised edges is prepared in advance. Instructions 160 is then imprinted on template 140 with instructions on how to use craft kit 100, including how to remove template 140 and embellish first craft item 110 with the template. Then, template 140 is removably attached to surface 120 of first craft item 110. Alternatively, template 140 can be removably attached to surface 120 of first craft item 110 before imprinting instruction 160 onto template 140. Last, template 140 is used to embellish first craft item 110.

In some embodiments, template 140 is removably attached to surface 120 of first craft item 110 via an adhesive. Exemplary adhesives include, without limitation, paper glue, multi-purpose glue, tacky glue, and double-sided adhesive tape. In some embodiments, the method of manufacturing craft kit 100 further comprises attaching additional decorative craft embellishments, such as beads, buttons, gems, shells, charms, ribbons, paints, stains, yarns, threads, flowers, jewels, feathers, mosaic tiles, stickers, fabric felts, wood accents, cabochons, stained glass, metal accents, plastic or EVA accents, glass accents, or combinations thereof

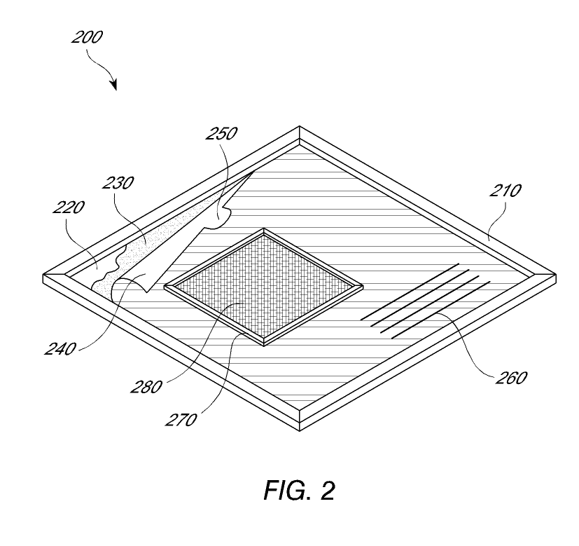

FIG. 2 illustrates a perspective view of an embodiment of a craft kit 200 comprising a first square-shaped craft item 210, having raised edges and a substantially flat surface 220. An adhesive layer 230 is optionally present and in direct contact with surface 220. A removable template 240 is removably attached to adhesive layer 230. In absence of adhesive layer 230, template 240 can also be directly attached to surface 220 or directly fitted between the raised edges of craft item 210. Template 240 can also comprise a pull tab 250 to facilitate the removal of the template. Instructions 260 on how to use craft kit 200 are imprinted on template 240.

As illustrated, first craft item 210 also comprises a second craft item 270 of a smaller size disposed within the first craft item. Second craft item 270 further comprises a substantially flat surface 280. Removable template 240 can be peeled off between first craft item 210 and second craft item 270.

In some embodiments, first craft item 210 can comprise additional craft items of smaller size disposed within craft item 210. In some embodiments, craft items 210 and 270, and surfaces 220 and 280 can comprise additional embellishments, such as beads, buttons, gems, pearls, shells, charms, ribbons, paints, stains, pictures, yarn, thread, flowers, jewels, feathers, mosaic tiles, stickers, fabric felts, wood accents, cabochons, stained glass, metal accents, plastic or EVA accents, glass accents, or combinations thereof

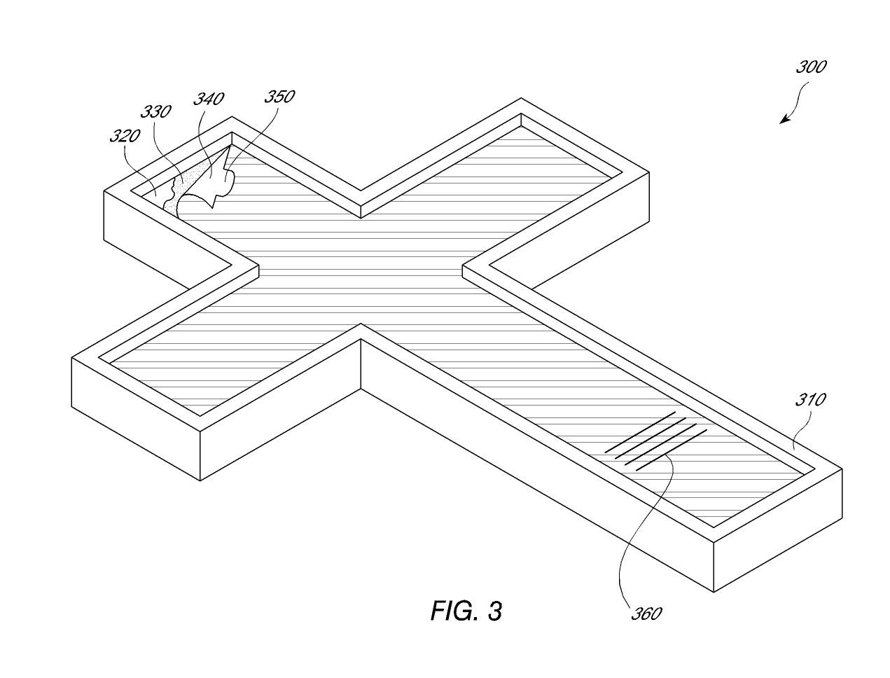

FIG. 3 illustrates a perspective view of an embodiment of a craft kit 300 comprising a first craft item 310 in the shape of a cross, and a substantially flat surface 320. An adhesive layer 330 is optionally present and in direct contact with surface 320. A removable template 340 is removably attached to adhesive layer 330. In absence of adhesive layer 330, template 340 can also be directly attached to surface 320 or directly fitted between the raised edges of craft item 310. Template 340 can also comprise a pull tab 350 to facilitate the removal of the template. In a preferred embodiment, instructions 360 on how to use craft kit 300 are imprinted on template 340.

In some embodiments, first craft item 310 can comprise additional craft items of smaller size disposed within craft item 310. In some embodiments, craft item 310 and surface 320 can comprise additional embellishments, such as beads, buttons, gems, pearls, shells, charms, ribbons, paints, stains, pictures, yarn, thread, flowers, jewels, feathers, mosaic tiles, stickers, fabric felts, wood accents, cabochons, stained glass, metal accents, plastic or EVA accents, glass accents, or combinations thereof .

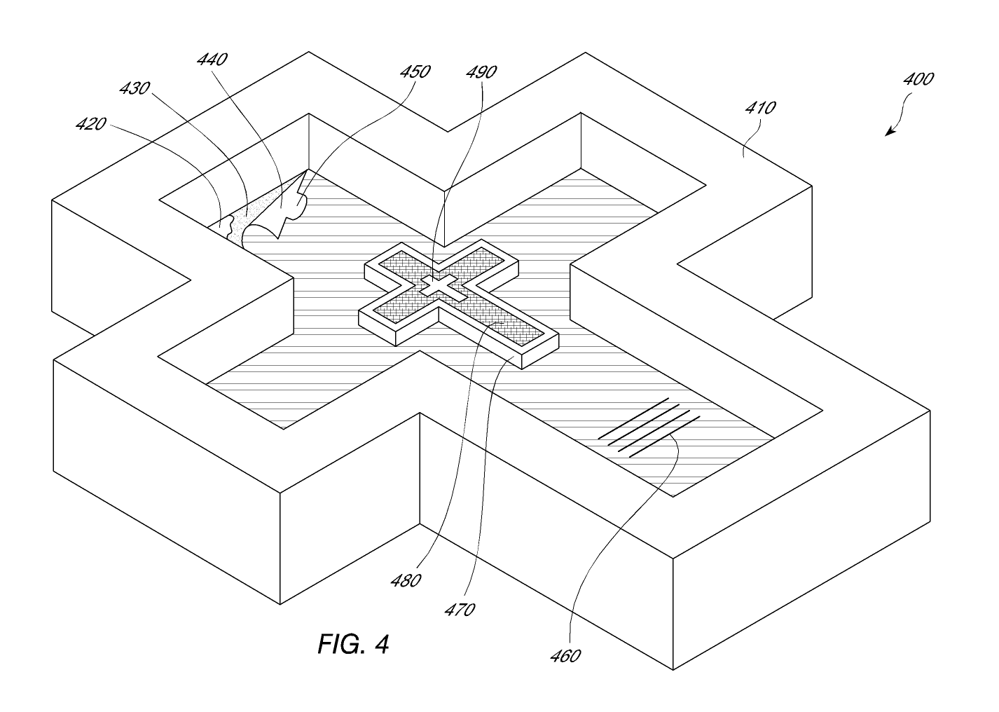

FIG. 4 illustrates a perspective view of an embodiment of a shadow box craft kit 400 comprising first craft item 410 in the shape of a cross, and a substantially flat surface 420. An adhesive layer 430 is optionally present and in direct contact with surface 420. A removable template 440 is removably attached to adhesive layer 430. In absence of adhesive layer 430, template 440 can also be directly attached to surface 420 or directly fitted between the raised edges of craft item 410. Template 440 can also comprise a pull tab 450 to facilitate the removal of the template. Instructions 460 on how to use craft kit 400 are imprinted on template 440. First craft item 410 also comprises a second craft item 470 in the shape of a cross disposed within first craft item 410. Second craft item 470 further comprises a substantially flat surface 480 and an embellishment 490. Removable template 440 can be peeled off between first craft item 410 and second craft item 470.

In some embodiments, first craft item 410 can comprise additional craft items of smaller size disposed within craft item 410. In some embodiments, craft items 410 and 470, and surfaces 420 and 480 can comprise additional embellishments, such as beads, buttons, gems, pearls, shells, charms, ribbons, paints, stains, pictures, yarn, thread, flowers, jewels, feathers, mosaic tiles, stickers, fabric felts, wood accents, cabochons, stained glass, metal accents, plastic or EVA accents, glass accents, or combinations thereof

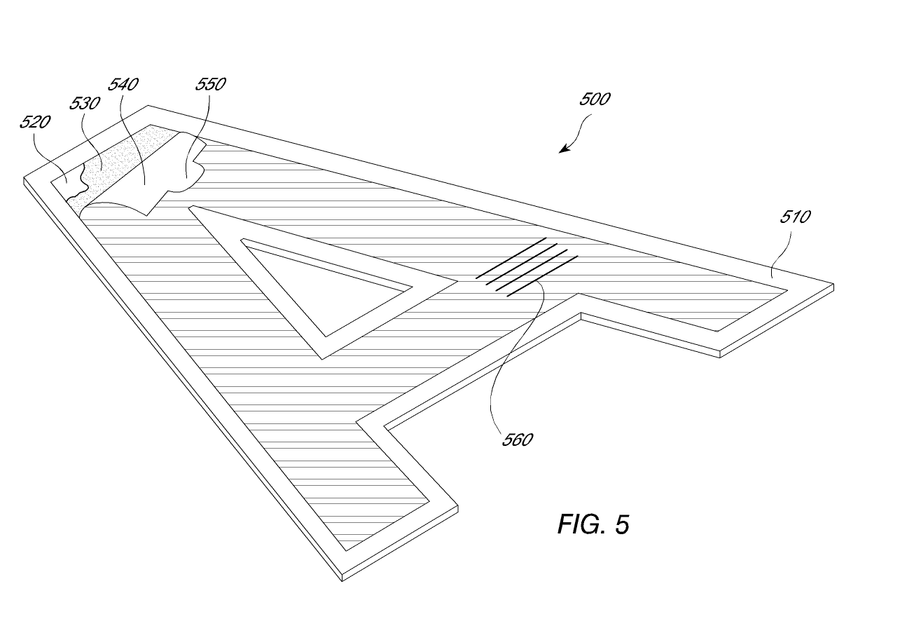

FIG. 5 illustrates a perspective view of an embodiment of a letter-shaped craft kit 500 comprising a first craft item 510 in the shape of letter “A,” and a substantially flat surface 520. An adhesive layer 530 is optionally present and in direct contact with surface 520. A removable template 540 is adhered to adhesive layer 530. In absence of adhesive layer 530, template 540 can be attached to surface 520 directly or fitted between the raised edges of craft item 510. Template 540 can also comprise a pull tab 550 to facilitate the removal of the template. Instructions 560 on how to use craft kit 500 are imprinted on template 540. Removable template 540 can be peeled off partially or completely.

In some embodiments, craft item 510 can comprise one or more craft items of smaller sizes disposed within craft item 510. In some embodiments, craft item 510 and surface 520 can comprise additional embellishments, such as beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

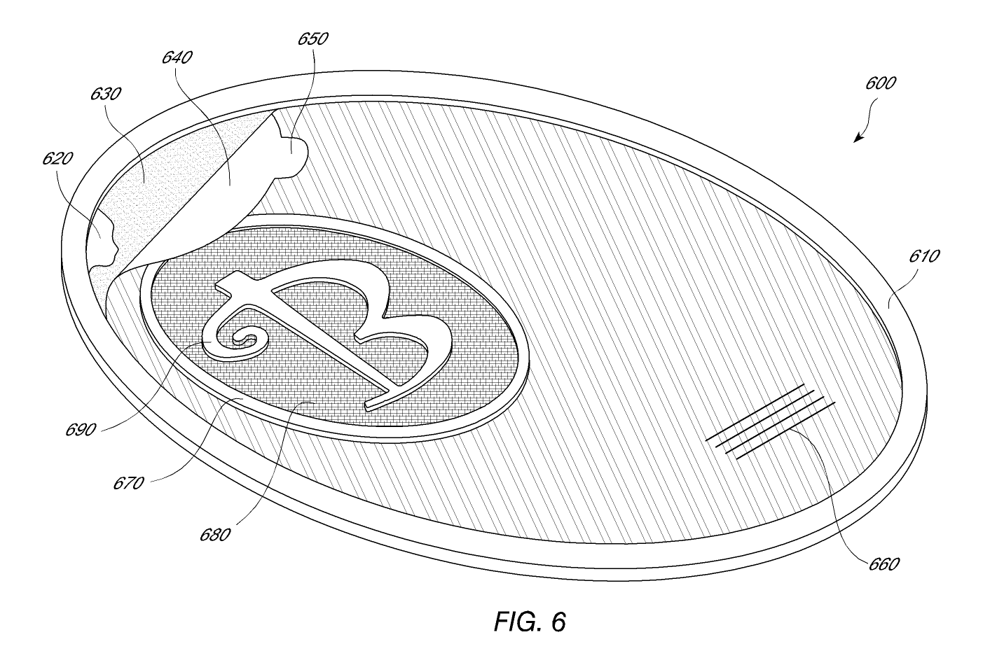

FIG. 6 illustrates a perspective view of an embodiment of a craft kit 600 comprising a first oval-shaped craft item 610, and a substantially flat surface 620. An adhesive layer 630 is optionally present and in direct contact with surface 620. A removable template 640 is removably attached to adhesive layer 630. In absence of adhesive layer 630, template 640 can also be directly attached to surface 620 or directly fitted between the raised edges of craft item 610. Template 640 can also comprise a pull tab 650 to facilitate the removal of the template. Instructions 660 on how to use craft kit 600 are imprinted on template 640. First craft item 610 also comprises a second oval-shaped craft item 670 disposed within first craft item 610. Second craft item 670 further comprises a substantially flat surface 680 and a third letter-shaped craft item 690 in the shape of a letter “B” disposed within second craft item 670. Removable template 640 can be peeled off between first craft item 610 and second craft item 670.

In some embodiments, surface 680 can also comprise a removable template that can be peeled off between second craft item 670 and third craft item 690. In some embodiments, craft items 610 and 670 can further comprise additional craft items of smaller sizes disposed within craft items 610 or 670. In some embodiments, craft items 610, 670 and 690, and flat surfaces 620 and 680 can optionally comprise additional embellishments, such as beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

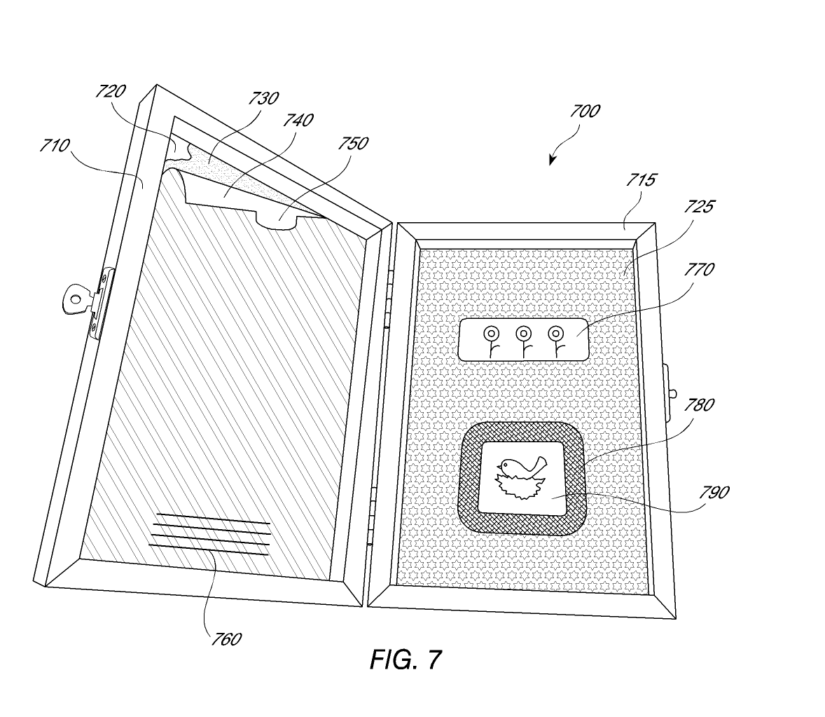

FIG. 7 illustrates a perspective view of an embodiment of a bi-fold box craft kit 700 comprising one half of the unfinished inner surface to be decorated and one half of the finished inner surface. The unfinished left side comprises a first craft item 710 and a substantially flat surface 720. An adhesive layer 730 is optionally present and in direct contact with surface 720. A removable template 740 is removably attached to adhesive layer 730. In absence of adhesive layer 730, template 740 can also be directly attached to surface 720 or directly fitted between the raised edges of craft item 710. Template 740 can also comprise a pull tab 750 to facilitate the removal of the template. Instructions 760 on how to use craft kit 700 are imprinted on template 740. The finished right side comprises a first craft item 715 as part of the frame of box 700. The removable template has been peeled off and replaced with a cut material 725. Additional embellishments 770, 780 and 790 in the forms of a picture, a fabric felt, and a sticker are adhered to the surface of cut material 725.

In some embodiments, craft items 710 and 715 can further comprise additional craft items of smaller sizes disposed within craft items 710 or 715. In some embodiments, craft items 710, and 715, surface 720, and cut material 725, can comprise additional embellishments, such as beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

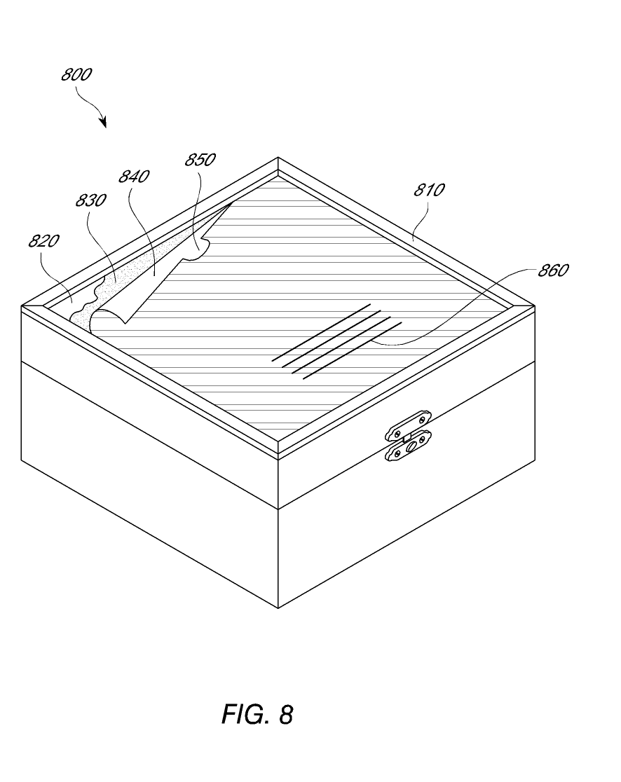

FIG. 8 illustrates a perspective view of an embodiment of a storage box craft kit 800 comprising a first square-shaped craft item 810, and a substantially flat surface 820. An adhesive layer 830 is optionally present and in direct contact with surface 820. A removable template 840 is adhered to adhesive layer 830. When adhesive layer 830 is absent, template 840 can be attached to surface 820 directly or fitted between the raised edges of craft item 810. Template 840 can also comprise a pull tab 850 to facilitate the removal of the template. Removable template 840 can be peeled off partially or completely. Instructions 860 on how to use craft kit 800 are imprinted on template 840.

In some embodiments, craft item 810 can comprise one or more craft items of smaller sizes disposed within craft item 810. In some embodiments, craft item 810 and surface 820 can comprise additional embellishments, such as beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for the methods disclosed herein, the functions performed in methods can be implemented in various orders. Furthermore, the outlined steps and operations are only provided as examples, and some of the steps and operations can be optional, combined into fewer steps and operations, or expanded into additional steps and operations without detracting from the essence of the disclosed embodiments.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting, with the true scope and spirit being indicated by the following claims.

What is claimed is:

1. A kit for embellishing a decorative craft item comprising:
a first craft item having a substantially flat surface and raised edges defining the shape of said first craft item;
a removable template, wherein said removable template is removably attached to said substantially flat surface of said first craft item; and
instructions on said template for removing said removable template from said first craft item and using said template to embellish said decorative craft item.

2. The kit of claim 1, wherein said first craft item comprises a shape selected from the group consisting of heart, triangle, square, rectangle, oval, circle, cross, star, letter, bone, arrow, and animals.

3. The kit of claim 1, wherein said template comprises a pull tab.

4. The kit of claim 1, wherein said template is constructed from flexible plastic, or paper.

5. The kit of claim 1, wherein said first craft item is constructed from a material selected from the group consisting of wood, plastic, paper, clay, rubber, metal, foam, and wax.

6. The kit of claim 5, wherein said first craft item comprises wood.

7. The kit of claim 1, wherein said instructions further comprise positioning said template onto a surface of a material selected from the group consisting of fabric, lace, leather, stationery, paper, cutting said material along the edges of said template, and adhering said material to the substantially flat surface of said first craft item.

8. The kit of claim 1, wherein said instructions further comprises tracing said template onto said material before cutting.

9. The kit of claim 7, wherein said instructions further comprise advising a user to add one or more craft embellishments to the material adhered to the substantially flat surface of said first craft item.

10. The kit of claim 7, wherein said embellishments are selected from beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof

11. The kit of claim 1, further comprising a second craft item of a smaller size disposed within said first craft item, wherein said removable template is positioned between said first and second craft item on the surface of said craft item.

12. The kit of claim 1, wherein said first craft item is selected from the group consisting of a picture frame, a jewelry box frame, a storage box frame, a shadow box frame, and a grid frame.

13. The kit of claim 1, wherein said template is removably attached to said first craft item with an adhesive.

14. A method of embellishing a decorative craft item, comprising:
providing a decorative craft kit comprising a first craft item having a substantially flat surface and raised edges defining a shape of said first craft item, and a template removably attached to the surface of said first craft item;
removing said template from said decorative craft item;
cutting a material in the shape of said template; and
transferring said cut material onto the surface of said first craft item.

15. The method of claim 14, further comprising tracing the shape of said template onto said material before cutting.

16. The method of claim 14, further comprising adhering said cut material to the surface of said first craft item.

17. The method of claim 16, further comprising embellishing said craft item by adhering one or more craft embellishments selected from beads, buttons, gems, pearls, shells, charms, ribbons, paints, stains, pictures, yarns, threads, flowers, jewels, feathers, mosaic tiles, stickers, fabric felts, wood accents, cabochons, stained glass, metal accents, plastic or EVA accents, glass accents, or combinations thereof.

18. A method of manufacturing a decorative craft kit, comprising:
providing a craft item having a substantially flat surface and raised edges defining the shape of said craft item;
removably attaching a template to said substantially flat surface of said craft item;
providing instructions on said template for removing said template from said craft item; and
using said template to embellish said decorative craft item.

19. The method of claim 18, wherein the template further comprises a pull tab.

20. The method of claim 18, wherein the template is removably attached to the substantially flat surface of said craft item via an adhesive.

21. The method of claim 18, further comprising attaching one or more craft embellishments selected from beads, buttons, gems, pearls, shells, charms, ribbons, paints, stains, pictures, yarns, threads, flowers jewels, feathers, mosaic tiles, stickers, fabric felts, wood accents, cabochons, stained glass, metal accents, plastic or EVA accents, glass accents, or combinations thereof to said craft item.
